(19) United States
(12) Patent Application Publication
(10) Pub. No.: US 2023/0174237 A1
(43) Pub. Date: Jun. 8, 2023

(54) REMOVABLE DRESS COVER

(71) Applicant: Walter Dorwin Teague Associates, Inc., Seattle, WA (US)

(72) Inventors: Anthony Harcup, Snohomish, WA (US); Edson Alexandrino, Mukilteo, WA (US); James Blackwell, JR., Peachtree City, GA (US)

(21) Appl. No.: 18/076,187

(22) Filed: Dec. 6, 2022

Related U.S. Application Data
(60) Provisional application No. 63/286,479, filed on Dec. 6, 2021.

(51) Int. Cl. B64D 11/06; A47C 7/62

(52) U.S. Cl. CPC B64D 11/0647; B64D 11/0646; A47C 7/386

(57) ABSTRACT

An airplane seat cover is described. In an example, the airplane seat cover includes a first airplane cover section configured to be securely attached to a cushion of an airplane seat and including a first attachment device. The airplane seat cover also includes a second airplane cover section configured to be releasably attached to the first airplane cover section by including a second attachment device configured to be releasably attached to the first attachment device. Upon attachment of the second attachment device to the first attachment device, the first airplane cover section and the second airplane cover section form the airplane seat cover over the cushion of the airplane seat.

### CROSS-REFERENCES TO RELATED APPLICATIONS

This application claims the benefit of U.S. Provisional Patent Application No. 63/286,479, filed Dec. 6, 2021, the entire contents of which are hereby incorporated by reference for all purposes in its entirety.

### BACKGROUND

Airplane seats can include a cushioning attached to a rigid framework and a material surrounding the cushioning and framework. The rigid framework is typically attached to a cabin floor of an airplane. Different airplane seat configurations are possible, such as a single seat, two seats, three seats, four seats, or five seats in a single pod of seats that can be installed in one of the rows in an airplane cabin.

### BRIEF DESCRIPTION OF THE DRAWINGS

Various embodiments in accordance with the present disclosure will be described with reference to the drawings, in which:

FIG. 1 illustrates an example airplane environment including a row of seats, according to an embodiment of the present disclosure;

FIGS. 2A and 2B illustrates portions of example dress covers for use with a seat in the row of seats of FIG. 1, according to an embodiment of the present disclosure;

FIGS. 3 through 6 illustrates an example seat, according to an embodiment of the present disclosure;

FIG. 7 illustrates a cross section of an example seat, according to an embodiment of the present disclosure;

FIG. 8 illustrates a detailed view of an edge of an example seat cover piece including an attachment device, according to an embodiment of the present disclosure;

FIG. 9 illustrates implementing a sheet of material having one part number to dress multiple seats, according to an embodiment of the present disclosure; and

FIG. 10 illustrates a flow for using a single sheet of material with one part number to fully dress a row of seats, according to an embodiment of the present disclosure.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure relate to airplane seats and, more specifically, to airplane seat covers that can be used for airplane seats. An airplane seat cover can be designed according to at least two different sets of requirements. In particular, the airplane seat cover can be considered to include a passenger-facing section and a non-passenger facing section. The passenger-facing section can include the portion of the seat cover that a passenger typically uses (e.g., contacts frequently) and an airline typically customizes (e.g., for branding reasons). The non-passenger facing section can include the portion of the seat which the passenger typically, does not contact, and the airline typically does not customize. Due to the different uses of these two sections, the production considerations for the sections can vary. For example, it can be desirable for the passenger-facing section to be soft, replaceable, and easily customizable. Soft because this section can frequently and repeatedly come into contact with passengers. Replaceable because this section can experience a relatively larger amount of wear and tear than the non-passenger facing section. Easily modifiable because airlines typically use branding on it as part of customizing the cabin of an airplane. On the other hand, it can be desirable for the non-passenger facing section to be durable enough to withstand repeated use. The production considerations for the non-passenger facing section can be less focused on customizability as it can be less viewable. Likewise, replaceability may also be less important because there can be less of an expectation that this section will require replacement during the lifetime of the seat. Accordingly, the two sections can be made of different materials and can be attached together via a releasable attachment mechanism. In one example, the non-passenger facing section can be securely attached to the airplane seat, whereas the passenger-facing section can be releasably attached to the non-passenger facing section. As needed, an in-use passenger-facing section can be quickly and easily replaced with a replacement or new passenger-facing section by de-attaching the in-use passenger-facing section from the non-passenger facing section and attaching the replacement or new or replacement passenger-facing section to the same non-passenger section. Whereas the same non-passenger section remains the same and need not be changed, and whereas the airplane seat need not be removed or de-attached from an airplane cabin floor, the new or replacement passenger-facing section can be made of a different material and/or has a different branding (or, more generally, look and/or feel) than the in-use passenger facing section. A such, using such sectioned replaceable seat covers makes repeated replacement highly practical, repeatable and quick and uses less material and labor relative to re-dressing the entire seat.

Embodiments and techniques described herein are directed to an airplane seat including a seat cover (e.g., a dress cover). The airplane seat can include a cushion coupled with a frame (e.g., a structure). A seat cover can be attached to the frame to cover some or all of the framework. The seat cover can include one or more pieces. For example, the seat cover can include a back portion that covers the backrest of the seat and a bottom portion that covers the seat pan of the seat. The portions of the seat cover can be attached (e.g., to one another) via one or more attachment devices. For example, the portions of the seat cover can be attached via hook and loop connectors, zippers, magnets, buttons, adhesives, string, twine, rivets, and/or any suitable attachment device.

Turning now to a particular example, in this example, an airplane seat can include a frame with a backrest and a seat pan. Cushioning can be coupled with the frame, for example, at the backrest and the seat pan. A cover can be positioned over the cushioning and the seat frame. The cover can include multiple pieces. The pieces can be attached to one another using one or more attachment devices. One or more of the pieces of the cover can be releasably attached such that the pieces can be removed from the seat. A replacement piece can be releasably attached to the other pieces, for example, via the attachment devices. In various embodiments, the removable pieces can be or include material that is different than the material of another of the pieces. For example, the removable pieces can be or include material that is softer, more comfortable, and/or easier to clean than other pieces. The removable pieces can additionally or alternatively include markings (e.g., a logo) such that the pieces can be removed and replaced with a different piece having a different markings.

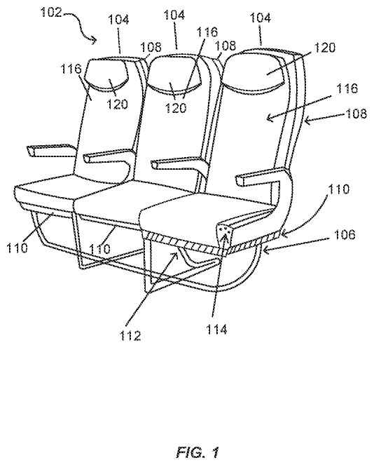

Turning now to the figures, FIG. 1 illustrates an example airplane environment 100 (e.g., an interior of an airplane) including a row of seats 102, according to an embodiment of the present disclosure. The row of seats 102 includes three seats 104, however, the row of seats may include any suitable number of seats 104. The seats 104 can include a frame 106 (e.g., a support frame). The frame 106 can be or include one or more pieces that can be formed into the shape of a seat 104. For example, the pieces of the frame 106 can be formed into a seat 104 with an upper seat portion 108 (e.g., a backrest), a lower seat portion 110 (e.g., a seat pan), and/or an attachment portion 112 (e.g., a portion that can be used to attach the seat 104 to the airplane environment 100). The frame 106 can be or include metal and/or any suitable material that is strong enough to support one or more passengers.

In various embodiments, cushioning 114 can be attached to the frame 106. The cushioning 114 can increase the comfort for passengers sitting in the seat 104 and/or provide support to a passenger sitting in the seat 104. For example, the cushioning 114 can be coupled with the frame 106 at the upper seat portion 108 and/or to the lower seat portion 110 (e.g., to provide support and/or comfort to a passenger sitting in the seat 104). The cushioning 114 can be or include foam, padding, cushion material, rubber, a membrane, and/or any suitable material that can provide support and/or comfort to passengers sitting in the seats 104. In various embodiments, the cushioning 114 can be or include a membrane attached to the frame 106. For example, the cushioning 114 can be or include a membrane stretched between the frame 106 of the seatback of the seat 104.

A cover 116 can be positioned over various portions of the frame 106 and/or the cushioning 114. The cover 116 can include one or more pieces. Additionally or alternatively, the cover 116 can be or include one or more materials. For example, a first piece of the cover 116 can include a first material and a second piece of the cover 116 can include a second material. In various embodiments, the material of the piece of the cover 116 can be at least partially dependent on where the piece of the cover 116 is located on the seat 104. For example, at locations where a passenger contacts the cover 116, the pieces of the cover 116 can be or include softer and/or more comfortable material, which can be used to cover the frame 106 (e.g., the lower seat portion 110 and/or the upper seat portion 108). Additionally or alternatively, at locations where a passenger does not contact and/or has minimal contact with the cover 116, the pieces of the cover 116 can be or include stronger and/or more resilient material.

In various embodiments, one or more pieces (e.g., portions) of the cover 116 can include markings. The markings can be or include words, decals, drawings, and/or any suitable mark. The markings included on one or more pieces of the cover 116 may be the same for each seat 104 in a row of seats 102. Additionally or alternatively, the markings may vary between seats 104 in a row of seats 102. For example, each seat 104 in a row of seats 102 include different markings, such that the seats 102 are distinguishable between each other.

The pieces of the cover 116 can be attached to one another, for example, with an attachment device 118. The attachment device 118 can attach the pieces of the cover 116 with one another and/or attach the pieces of the cover 116 to the frame 106. The attachment device 118 can be positioned on one or more of the edges of a piece of the cover 116. For example, the attachment device 118 can be positioned on edges of a piece of the cover 116 such that the piece of the cover 116 can be attached to other pieces of the cover 116 and/or the frame 106. The attachment device 118 can be or include hook and loop connectors, zippers, magnets, buttons, adhesives, string, twine, rivets, and/or any suitable attachment device.

In some embodiments, the attachment device 118 can include a safety mechanism (e.g., a locking mechanism). For example, the attachment device 118 can include a locking mechanism such that the locking mechanism has to be unlocked before the attachment device 118 can be used (e.g., used to disengage the pieces of the cover 116 from one another). The locking mechanism can be or include a lock, a locking zipper, and/or any suitable locking and/or safety mechanism. By implementing a safety mechanism, unauthorized tampering with the attachment device 118 can be prevented.

In various embodiments, one or more of the pieces of the cover 116 can be unattached from other pieces of the cover 116 and/or from the frame 106. For example, the attachment device 118 can be used to disengage a piece of the cover 116 from the other pieces of the cover 116 and/or from the frame 106. The piece of the cover 116 that is disengaged can be replaced by another piece. For example, a piece of the cover 116 that is damaged can be removed and replaced with a new piece of the cover 116. Additionally or alternatively, a piece of the cover 116 with a marking can be removed and replaced with another piece (e.g., another piece without a marking and/or with a different marking).

In some embodiments, one or more pieces of the cover 116 can be more securely attached to the frame 106 than other pieces of the cover 116. For example, pieces of the cover 116 that have no or minimal contact with passengers can be attached to the frame 106 and pieces of the cover 116 that are regularly contacted by the passengers can be attached to other pieces of the cover 116. The pieces of the cover 116 that are attached to the other pieces of the cover 116 can be more easily removed and replaced (e.g., due to damage and/or regular wear), while the pieces of the cover 116 that are coupled with the frame 106 can be more securely attached to the frame 106.

In further embodiments, the cover 116 can include multiple layers of material and/or multiple layers of pieces of the cover 116. For example, a first piece of material (e.g., an inner piece) can be attached to the frame 106 and/or the cushioning 114 and a second piece of material (e.g., an outer piece) can be positioned on top of the first piece of material and attached to the first piece of material with the attachment device 118. The outer piece of material can be attached to the inner piece of the material using one or more attachment devices 118 (e.g., hook and loop connectors, magnets, and/or any suitable attachment device). The inner piece of material can be attached to the frame 106 and/or the cushioning 114 using one or more attachment devices 118. For example, the inner piece of material can be attached to the frame 106 and/or the cushioning 114 using hook and loop connectors, magnets, and/or any suitable attachment device. In some embodiments, the inner piece can be attached to the frame 106 and/or the cushioning 114 such that the inner piece can pass inspection and/or certification of the seat 104. For example, the inner piece can allow the seat 104 to be certified such that adding or removing the outer piece does not require recertifying the seat.

The inner and outer pieces of material can be or include the same material. However, the inner and outer pieces of material can be or include different material. For example, the inner piece of material can be a rigid or semi-rigid and/or resilient material and the outer material can be or include comfortable material. The outer piece of material can additionally or alternatively include markings words and/or decals).

In various embodiments, the seat 104 can include a headrest 120, The headrest 120 can be attached to the seat 104 (e.g., the frame 106) such that the headrest 120 can be removed. The headrest 120 can be removed, for example, to provide access to one or more attachment devices 118. For example, an attachment device 118 can be positioned on an upper portion (e.g., an upper edge) of a piece of the cover 116 and the headrest 120 can be coupled with the frame such that the attachment device 118 on the upper edge cannot be accessed until the headrest 120 is removed. The headrest 120 can include one or more pieces of the cover 116. For example, the headrest 120 can include a piece of the cover 116 that can be removed and replaced.

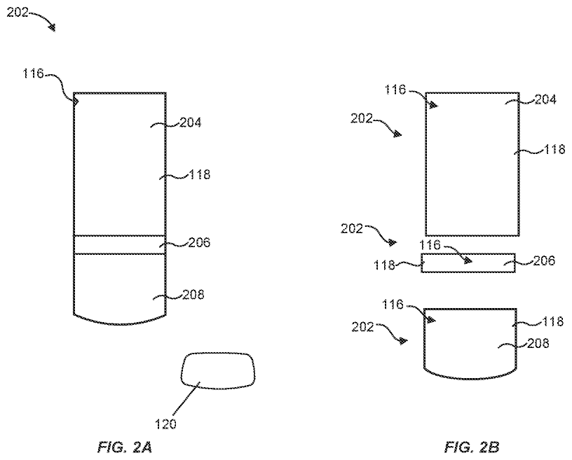

Turning to FIGS. 2A and 2B, portions 202 of example dress covers 116 for use with a seat 104 in the row of seats 102 of FIG. 1 are shown, according to an embodiment of the present disclosure. The pieces 202 can include one or more attachment devices 118 extending around some or all of the edges of the pieces 202. For example, the pieces 202 can include a zipper and/or a locking zipper extending around some or all of the edges of the pieces 202. The attachment device 118 can be attached to a corresponding attachment device 118 on another piece 202 of the cover 116. For example, the attachment device 118 can be attached to an attachment device 118 on a piece 202 attached to the frame 106.

As shown in FIG. 2A, the pieces 202 can include multiple sections. For example, the pieces 202 can include a headrest section 120, a back section 204, a connector section 206, and a seat section 208. The sections 120, 204, 206, 208 can be permanently or semi-permanently attached to one another. However, as shown in FIG. 2B, the sections 120, 204, 206, 208 may be separate pieces 202. For example, the pieces 202 can each include attachment devices 118 such that the different pieces can be attached to one another and/or to pieces 202 attached to the frame 106. For example, the connector section 206 can include multiple attachment devices 118 (e.g., a first attachment device 118 on a first side and a second attachment device 118 on a second side). The connector section 206 can connect to the back section 204 and the seat section 208 (e.g., via the attachment devices 118).

The sections 120, 204, 206, 208 can include the same or similar materials. However, the sections 120, 204, 206, 208 may include different materials. For example, the seat section 208 can include stronger and/or more resilient material than the connector section 206 and/or the back section 204.

In various embodiments, the pieces 202 can include multiple attachment devices 118. For example, the pieces 202 can include a first attachment device 118 (e.g., a zipper) extending around most of the edges and a second attachment device 118 (e.g., a hook and loop connector) around some of the edges.

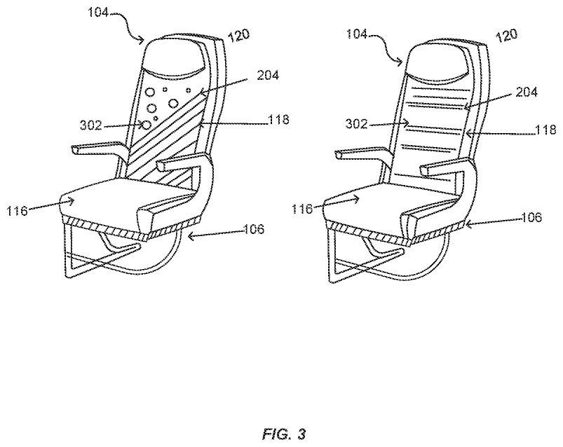

Turning to FIGS. 3 through 6, an example seat 104 is shown, according to an embodiment of the present disclosure. As shown in FIG. 3, the example seat 104 can include a cover 116 with multiple pieces. For example, the cover 116 can include a back piece 204. The back piece 204 can be connected with other pieces of the cover 116 using one or more attachment devices 118 (e.g., a zipper and/or hook and loop connectors). The back piece 204 can be or include different material than the other pieces of the cover 116. For example, the back piece 204 can be or include material that is more comfortable than the other pieces of the cover 116. In various embodiments, one or more pieces of the cover 116 can be permanently or semi-permanently attached to the frame 106. For example, the pieces of the cover 116 that are connected with the back piece 204 can be permanently or semi-permanently attached to the frame 106. The back piece 204 can be attached to the other pieces of the cover 116 (e.g., with the attachment devices 118) such that the back piece 204 can be disconnected and removed. For example, the back piece 204 can be removed and replaced (e.g., with a different back piece 204).

In various embodiments, the back piece 204 can include one or more markings 302. The markings can be or include words, decals, drawings, and/or any suitable mark. The back piece 204 with a first marking 302 can be removed and replaced with a back piece 204 having a different marking 302 and/or no marking 302.

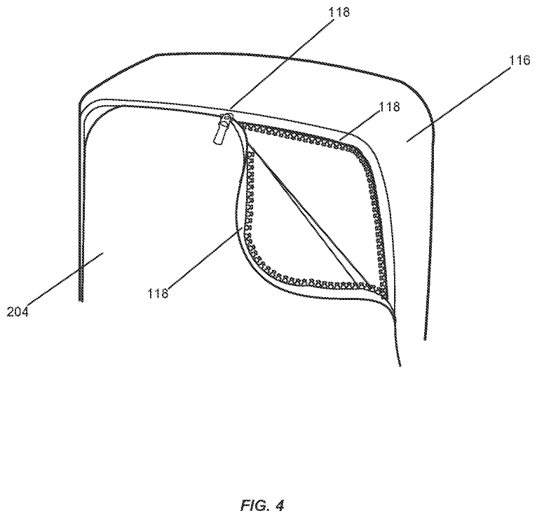

FIG. 4 illustrates a method of attaching the back piece 204 with other pieces of the cover 116, according to an embodiment of the present disclosure, A first attachment device 118 (e.g., hook and loop connectors) can be positioned on the upper edge of the back piece 204 for engagement with another piece of the cover 116. In various embodiments, the first attachment device 118 can be detached to allow access to a second attachment device 118. For example, the hook and loop connectors can be disengaged to allow access to a zipper.

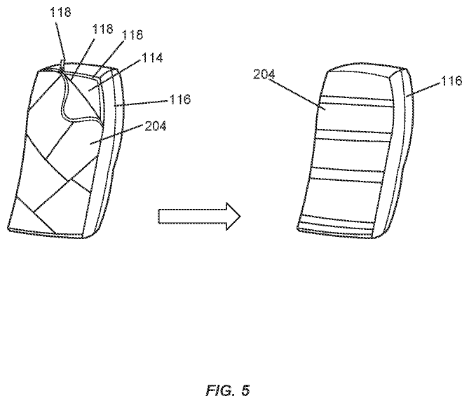

As shown in FIG. 5, the second attachment device 118 (e.g., the zipper) can be disengaged to allow for removal of the back piece 204 (e.g., from the other pieces of the cover 116 that are semi or permanently attached to the frame 106), according to an embodiment of the present disclosure. The back piece 204 can be removed and/or replaced, for example, with a new back piece 204.

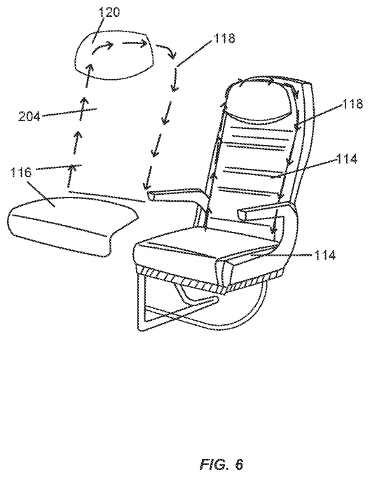

As shown in FIG. 6, removal of the back piece 204 can expose cushioning 114, according to an embodiment of the present disclosure. The cushioning 114 can include attachment devices 118 (e.g., hook and loop connectors). The attachment devices 118 can aid in the positioning of the back piece 204 (e.g., by holding the back piece 204 in place). In various embodiments, a piece of cover 116 can be positioned on the cushioning 114 (e.g., between the cushioning 114 and the back piece 204). For example, the piece of the cover 116 can be permanently or semi-permanently attached to the cushioning 114 and to the back piece 204. The removal of the back piece 204 can expose the piece of the cover 116.

The techniques described herein for attaching pieces of the cover 116 (e.g., in reference to FIGS. 3 through 6) can additionally or alternatively be used for attaching a seat section 208, a connector section 206, and/or a headrest 120. For example, the seat section 208 can be positioned over cushioning 114 and attached to other pieces of the cover 116 via an attachment device 118.

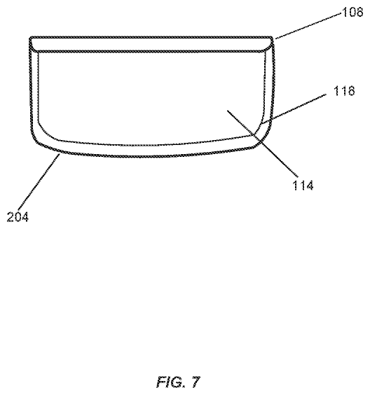

Turning to FIG. 7, a cross section of an example seat 104 is shown, according to an embodiment of the present disclosure. One or more pieces of the cover 116 may be used to dress an airplane seat 104. The pieces of cover 116 can be secured to the frame 106, cushioning 114, and/or other pieces of cover 116 with one or more attachment devices 118 (e.g., zipper). In some embodiments, the pieces of the cover 116 may be positioned such that, when the seat 104 is fully dressed, the one or more attachment devices 118 used to secure the cover 116 are hidden. For example, the edge of a piece of the cover 116 can extend beyond the attachment device 118, effectively hiding the attachment device 118 from view. The piece of cover 116 can be overlayed on the attachment device 118 to conceal the attachment device 118 partially or completely.

In various embodiments, a seat 104 can be dressed such that when one or more attachment devices 118 are engaged to attach the cover pieces 116 to the seat 104, the edges of the cover pieces 116 can meet. By having the cover pieces 116 touch or nearly touch, the attachment devices 118 securing the cover pieces together and/or to the seat 104 can be hidden. For example, a back piece 204 and another cover piece 116 can each have an attachment device 118 positioned along its edge. When the attachment devices 118 are engaged to secure the back piece 204 and the cover piece 116 to a seat 104, the edges of the back piece 204 and the cover piece 116 can touch or nearly touch. Thus, the attachment devices 118 used to secure the back piece 204 and cover piece 116 may be hidden by the two meeting edges. Obscuring the attachment devices 118 either partially or wholly can prevent unwanted tampering with the attachment devices 118, as well as create a clean appearance when the seat 104 is fully dressed.

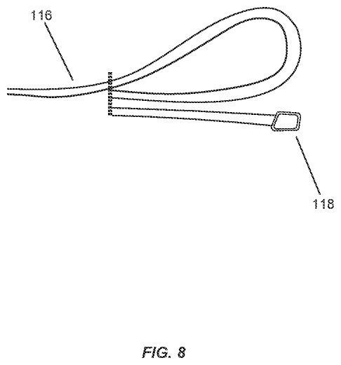

FIG. 8 illustrates a detailed view of an edge of an example seat cover piece 116 including an attachment device 118, according to an embodiment of the present disclosure. As shown in FIG. 8, a cover piece 116 and attachment device 118 can be configured such that the cover piece 116 may extend over the attachment device 118. In some embodiments, a portion of the edge of the cover piece 116 may be folded, creating a loop of material (e.g., leather, fabric, etc.), and coupled with (e.g., securely attached thereto by means of stitching for instance the attachment device 118. For example, the attachment device 118 and the looped edge of the cover piece 116 may be secured to the cover piece 116 using stitches that pierce all three layers (e.g., the edge of the cover piece 116, the looped portion of the cover piece 116, and the attachment device 118).

In various embodiments, the looped edge of the cover piece 116 may be used to hide the attachment device 118 stitched along side the cover piece 116. For example, the attachment device 118 can be attached to the cover piece 116 such that it is disposed between the cover piece 116 and the cushioning 114, Therefore, when the attachment device 118 is used to secure a cover piece 116 to a seat 104, the cover piece 116 can hide the attachment device 118 that is placed between the cover piece 116 and the cushioning 114.

In some embodiments, the looped edge of the cover piece 116 can extend over and be aligned with the attachment device 118, as shown in FIG. 8. By aligning a looped edge of a cover piece 116 with an attachment device 116 secured to the cover piece 116, the attachment device 118 can be partially or completely hidden by the cover piece 116. For example, when a cover piece 116 is used to dress a seat 104, an attachment device 118 can be blocked from view by a looped edge of the cover piece 116 aligned with and secured to (e.g., stitched) the attachment device 118. Attachment device 118 can further be obscured when two cover pieces are engaged. For example, two cover pieces 116 can be attached to a seat 104 using attachment devices 118 secured along the looped edges of the cover pieces 116. When the attachment devices 118 are engaged, the overhanging looped edges of the cover pieces 116 may touch or nearly touch. Thus, when a seat 104 is fully dressed and the attachment devices are engaged, the attachment devices 118 can be hidden by the meeting looped edges of the cover pieces 116. According to such embodiments, in some examples, two cover pieces 116 are used, where the attachment device 118 is coupled to both (e.g., one zipper side attached to one cover piece 116, and another zipper side attached to the other cover piece 116). Each of these two pieces can be looped and coupled with the relevant portion of the attachment device 118 (e.g., the relevant zipper side). The formed loops (e.g., their edges) can overlap, be aligned, or form a small gap under which the attachment device 118 is found such that this attachment device 118 is hidden (e.g., the zipper head is aligned with the overlap, alignment, or gap).

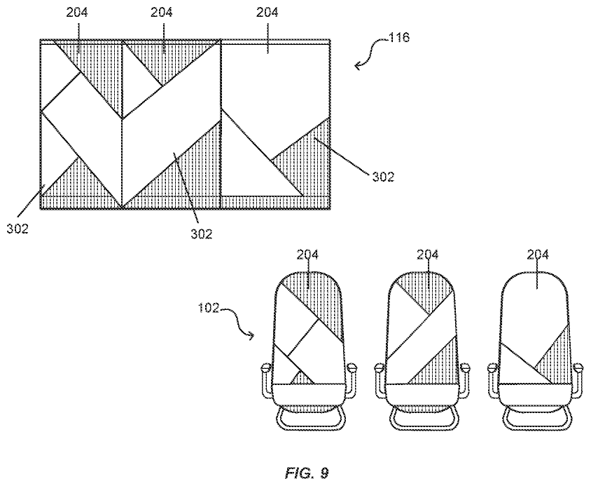

Turning to FIG. 9, implementing a sheet of material having one part number to dress multiple seats 104 is shown, according to an embodiment of the present disclosure. In various embodiments, multiple cover pieces 116 can be derived from a single sheet of material having one part number and used to dress a row of seats 102. The single sheet of material may include one or more markings 302, which can be used to create multiple cover pieces 116 one or more marking 302. In some embodiments, when the single sheet of material with one or more markings 302 is cut, each seat 104 in a row of seats 102 may display the same or similar design pattern. Additionally, and/or alternatively, the single sheet of material with one or more markings 302 can be cut such that each seat 104 in a row of seats 102 displays a dissimilar design pattern. For example, a single sheet of material with one part number can depict a series of markings 302 and be cut such that each resulting cover piece 116 depicts a different combination of markings 302. Then, when the multiple cover pieces 116 are used to dress a row of seats 102, each seat 104 may show a different combination of markings. Therefore, a single sheet of material with one part number can be used to dress each seat in a row of seats 102 with a different pattern.

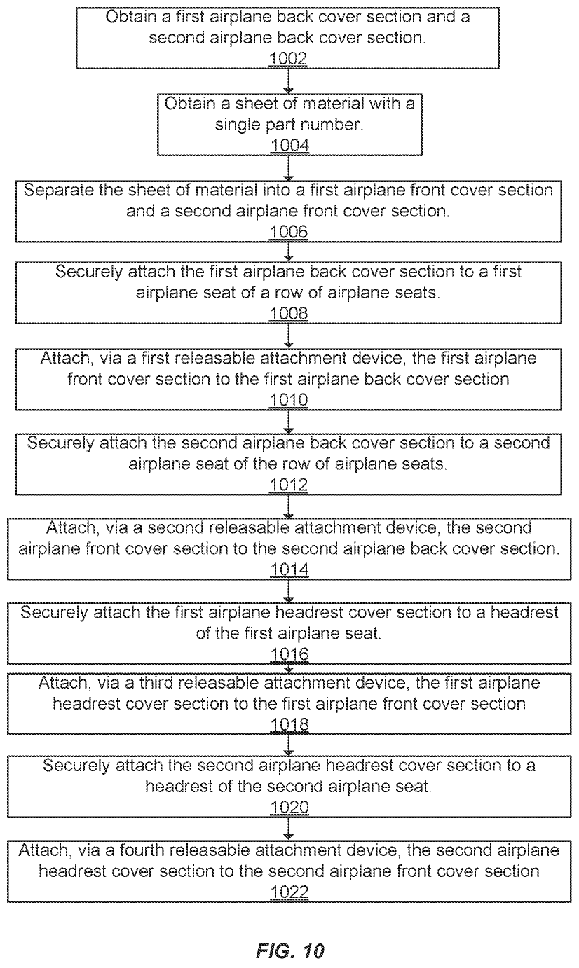

FIG. 10 illustrates a flow for using a single sheet of material with one part number to fully dress a row of seats 102, according to an embodiment of the present disclosure. In an example, a single sheet of material with a single part number can be separated into multiple seat front cover pieces 116 for dressing a row of airplane seats 102. A back cover piece 116 may be positioned over cushioning 114 and secured to a seat 104 in the row of airplane seats 102. Releasable attachment devices 118 may be implemented to attach a front cover piece 116, sourced from a single sheet of material with a single part number, to the back cover piece 116 secured to the seat 104. In some embodiments, an additional seat cover piece 116 can be positioned over a headrest 120 and secured to the front cover piece 116 using an attachment device 118. This method of dressing a seat 104 may be repeated for each seat 104 in a row of seats 102 such that each seat 104 includes at least a front cover piece 116 that originated from a single sheet of material with a single part number.

In an example, the flow includes operation 1002, where a first airplane back cover section 116 and a second airplane back cover section 116 are obtained. For instance, multiple back cover sections 116 can be acquired to dress each seat 104 in a row of airplane seats 102. The flow includes operation 1004, where a single sheet of material with a single part number is obtained. For instance, material to dress multiple seats 104 in a row of seats 102 can be obtained, where the material may be presented as a single sheet with one part number. The material can further include one or more markings 302. The flow includes operation 1006, where the sheet of material is separated into a first and second airplane cover section 116. For example, the single sheet of material may be sufficiently large enough such that it can be cut into more than one front seat cover piece 116. If the single sheet of material includes one or more marking 302, the separation of the sheet of material can create front seat cover pieces 116 with differing sets of markings 302. The flow includes operation 1008, where the first airplane back cover section 116 is securely attached to a first airplane seat 104 in a row of airplane seats 102. For example, an attachment device 118 can be positioned on at least part of the edge of the first back cover section 116. The attachment device 118 can be secured to the cushioning 114 and/or the frame 106 of the first airplane seat 104, which, in turn, firmly attaches the first back cover section 116 to the first airplane seat 104. The flow further includes 1010, where, via a first releasable attachment device 118, the first airplane front cover section 116 is attached to the first airplane back cover section 116. For instance, the first airplane front cover section 116, cut from the single sheet of material with one part number, may include a first releasable attachment device 118 positioned on or near at least part of the edge of the first front cover section 116. The first attachment device 118 can be engaged to the first back cover section 116 to fasten the first front cover section and the first back cover section together. The flow includes 1012, where the second airplane back cover section 116 is securely attached to a second airplane seat 104 of the row of airplane seats 102. For example, a second airplane back cover section 116 may be secured to a second airplane seat 104 in a similar manner as the first airplane back cover section 116 was secured to the first airplane seat 104. An attachment device 118 can be positioned on at least a part of the edge of the second back cover section 116 and used to secure the second back cover section 116 to the second airplane seat 104. The flow includes 1014, where the second airplane front cover section 116 is attached, via a second releasable attachment device 118, to the second airplane back cover section 116. For example, the second airplane front cover section 116, cut from the same sheet of material with one part number that the first airplane front cover section 116 was cut from, may include a second releasable attachment device 118 positioned on or near at least a portion of the second airplane front cover section 116. The second releasable attacher ent device 118 can be engaged with the second airplane back cover section 116. Thus, the second airplane front cover section 116 may be attached to the second airplane back cover section 116 using the second releasable attachment device 118. The flow further includes 1016, where the first airplane headrest cover section 116 is securely attached to a headrest 120 of the first airplane seat 104. For example, the first airplane headrest cover section 116 may include an attachment device 118 to enable to the first airplane headrest cover section 116 to be secured to the first airplane seat 104. The flow includes 1018, where using a third releasable attachment device 118, the first airplane headrest cover section 116 is attached to the first airplane front cover section 116. For instance, the first airplane headrest cover section 116 may include a third releasable attachment device 118 positioned on or near at least a portion of the edge of the first airplane Nearest cover section 116. By affixing the third releasable attachment device 118 to the first airplane front cover section 116, the first airplane headrest cover section 116 may be attached to the first airplane front cover section 116. The flow further includes 1020 where the second airplane headrest cover section 116 is securely attached to the headrest 120 of the second airplane seat 104, For example, similar to first airplane headrest cover section 116, the second airplane headrest cover section 116 may include an attachment device 118 enabling the second airplane headrest cover section 116 to be secured to the second airplane seat 104. Lastly the flow includes 1022 where, via a fourth releasable attachment device 118, the second airplane headrest cover section 116 is attached to the second airplane front cover section 116. For example, similar to the first airplane headrest cover section 116, the second airplane headrest cover section 116 may include a fourth releasable attachment device 118 positioned on or near at least a portion of the edge of the second airplane headrest cover section 116. By affixing the fourth releasable attachment device 118 to the second airplane front cover section 116, the second airplane headrest cover section 116 may be attached to the second airplane front cover section 116.

In the example flow, although operations are illustrated in connection with two airplane seats 104 of a row of airplane seats 102, more than two airplane seats 102 can be dressed using a single sheet of material with one part number. Furthermore, one or more markings 302 may be included on the single sheet of material with one part number, such that the fronte cover sections 116 cut from the sheet of material may also include some combination of the one or more markings 302.

Based on the disclosure and teachings provided herein, a person of ordinary skill in the art will appreciate other ways and/or methods to implement the various embodiments. The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having.” “including,” and “containing” are to be construed as open-ended terms (i.e., meaning “including, but not limited to,”) unless otherwise noted. The terms “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed, No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Various embodiments of this disclosure are described herein, including the best mode known to the inventors for carrying out the disclosure, Variations of those embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An airplane seat, comprising:
a frame;
cushioning coupled with the frame; and
a cover positioned over the cushioning, the cover comprising:
a first cover section securely coupled with the frame,
a second cover section releasably coupled with the first cover section,
a first attachment device positioned on at least a portion of an edge of the first cover section, and
a second attachment device positioned on at least a portion of an edge of the second cover section, wherein the first attachment device is configured to releasably attach with the second attachment device.

2. The airplane seat of claim 1, wherein the first cover section comprises a first material and the second cover section comprises a second material, the first and second material being different materials.

3. The airplane seat of claim 2, wherein the first material has higher strength ductility than the second material.

4. The airplane seat of claim 1, wherein the second cover section is replaced with a third cover section comprising a third attachment device positioned on at least a portion of an edge of the third cover section, wherein the third attachment device is configured to releasably attach with the first attachment device.

5. The airplane seat of claim 1, wherein at least the first or second attachment device comprises a locking mechanism configured to prevent use of the respective first or second attachment device absent an unlocking tool.

6. The airplane seat of claim 1, wherein an end of the first cover section is folded to form a loop, wherein the first attachment device is positioned over and secured to the loop such that the first attachment device is disposed between the first cover section and the cushioning and is aligned with the loop.

7. The airplane seat of claim 1, wherein when the first and second attachment devices are releasably attached, a portion of the cover extends over the first and second attachment devices.

8. The airplane seat of claim 1, further comprising:
a headrest securely coupled with the frame and positioned over the first and second attachment devices when the first and second attachment devices are releasably attached; and
a second cover positioned over the headrest, wherein the second cover comprises a third cover section securely coupled with the headrest and a fourth cover section releasably coupled with the first cover section, wherein a third attachment device is positioned on at least a portion of an edge of the third cover section and a fourth attachment device positioned on at least a portion of an edge of the fourth cover section, and wherein the third attachment device is configured to releasably attach with the fourth attachment device.

9. The airplane seat of claim 1, wherein at least the first or second attachment device comprises a zipper and a zipper head aligned with portions of the edge of the first cover section and the edge of the second cover section when the first and second cover section are releasably coupled.

10. An airplane seat cover system comprising:
a first airplane cover section configured to be securely attached to a cushion of an airplane seat and including a first attachment device; and
a second airplane cover section configured to be releasably attached to the first airplane cover section by including a second attachment device configured to be releasably attached to the first attachment device, wherein, upon attachment of the second attachment device to the first attachment device, the first airplane cover section and the second airplane cover section form an airplane seat cover over the cushion of the airplane seat.

11. The airplane seat cover system of claim 10, wherein the first airplane cover section comprises a first material and the second airplane cover section comprises a second material, the first and second material being different materials.

12. The airplane seat cover system of claim 11, wherein the first material has higher strength ductility than the second material.

13. The airplane seat cover system of claim 10, wherein the second airplane cover section is replaced with a third airplane cover section comprising a third attachment device positioned on at least a portion of an edge of the third airplane cover section, wherein the third attachment device is configured to engage with the first attachment device.

14. The airplane seat cover system of claim 10, wherein at least the first or second attachment device comprises a locking mechanism configured to prevent use of the respective first or second attachment device absent an unlocking tool.

15. The airplane seat cover system of claim 10, wherein at least the first or second attachment device comprises hook and loop connectors, zippers, magnets, buttons, adhesives, string, twine, or rivets.

16. The airplane seat cover system of claim 10, wherein when the first and second attachment devices are engaged, a portion of the airplane seat cover extends over the first and second attachment devices.

17. The airplane seat cover system of claim 10, further comprising:
a headrest securely coupled with a frame and positioned over the first and second attachment devices when the first and second attachment devices are releasably attached; and
a second cover positioned over the headrest, wherein the second cover comprises a third airplane cover section securely coupled with the headrest and a fourth airplane cover section releasably coupled with the first airplane cover section.

18. The airplane seat cover system of claim 17, wherein at least one of the third airplane cover section or the fourth airplane cover section is attached to a zipper head aligned with a seam formed by an edge of the third airplane cover section and an edge of the fourth airplane cover section when the third and fourth airplane cover sections are releasably coupled.

19. A method of dressing an airplane seat comprising:
obtaining a first airplane back cover section and a second airplane back cover section;
obtaining a first airplane front cover section and a second airplane front cover section from a material that has a particular part number and that is separable into multiple airplane front cover sections;
securely attaching the first airplane back cover section to a first airplane seat of a row of airplane seats;
releasably attaching, via a first releasable attachment device, the first airplane front cover section to the first airplane back cover section after the first airplane back cover section is securely attached to the first airplane seat;
securely attaching the second airplane back cover section to a second airplane seat of the row of airplane seats; and
releasably attaching, via a second releasable attachment device, the second airplane front cover section to the second airplane back cover section, the second airplane back cover section is securely attached to the second airplane seat.

20. The method of claim 19 further comprising:
obtaining a first airplane headrest cover section and a second airplane headrest cover section;
securely attaching the first airplane headrest cover section to a headrest of the first airplane seat;
releasably attaching, via a third releasable attachment device, the second airplane headrest cover section to the first airplane front cover section after the first airplane headrest cover section is securely attached to the headrest.
